(19) United States
(12) Patent Application Publication
(10) Pub. No.: US 2018/0099311 A1
(43) Pub. Date: Apr. 12, 2018

(54) LASER LEVELING NAVIGATION APPARATUS AND SYSTEM

(71) Applicant: Ultra V Coating, LLC, Batavia, OH (US)

(72) Inventor: Shawn A. Coons, Milford, OH (US)

(21) Appl. No.: 15/287,879

(22) Filed: Oct. 7, 2016

(51) Int. Cl. B05D 3/06; G01C 9/06

(52) U.S. Cl. CPC B05D 3/067; G01C 2009/066; G01C 9/06

(57) ABSTRACT

Two or more laser leveling apparatuses are joined together to form a composite laser leveling apparatus. Lasers are affixed to the composite apparatus for illuminating a laser line on a surface providing guidance for Ultraviolet (UV) curing of a UV coating applied to the surface during operation of a UV curing device.

### BACKGROUND

Curing Ultraviolet (UV) coatings on surfaces (such as flooring) is a time-consuming and laborious exercise. Devices exists to cure the coatings in shorter time-periods than what could be achieved without such devices. However, the devices require skill to operate and when incorrectly operated result in a “zippering” or “blistering” effect on the surface. Zippering occurs when the coating is not completely cured or cured in an uneven fashion by the curing device.

The surface with the cured coating appears to have seams, zippers, or blisters along portions of the coating that were cured at different rates. The appearance of the zippers along the cured surface is unsightly and requires a new UV coating and pass of the curing device to remedy. Further, if a strip of UV coating is missed during curing, the process has to be stopped, the area sanded off, recanted, and the curing process restarted to remedy to missed strip. This can be too expensive for some enterprises, such that the zippering remains. Moreover, applying a second or third coating to remedy zippering issues means that the surface being coated within the enterprise is unavailable for normal business activity. Many enterprises cannot be shut down for extended periods of time waiting on their flooring to be usable within the enterprises.

As a result, enterprises often elect to not use UV coatings on their enterprise flooring. Additionally, few service organizations can be hired by enterprises to apply UV coatings. This is largely because the service organizations will not warranty the finished curing or will only do so at unreasonable prices to the enterprises.

Consequently, market acceptance of UV surface coatings has not occurred to any significant degree even though UV coatings provide superior surface protection to other existing types of surface coatings and even though UV curing devices are available in the market for curing the UV coatings onto the surfaces.

### SUMMARY

In various embodiments, techniques, apparatuses, and systems for applying UV coatings on surfaces are presented.

Specifically, and in an embodiment, an apparatus is provided. The apparatus includes: a first laser level apparatus configured for holding a first laser, and a second laser level apparatus configured for holding a second laser. The first laser level apparatus is attachable to the second laser level apparatus to form the apparatus.

### BRIEF DESCRIPTION OF THE DRAWINGS

FIG. 1A is first end view of a laser level leveling apparatus, according to an example embodiment.

FIG. 1B is a second end view of a laser leveling apparatus, according to an example embodiment.

FIG. 1C is a side view of a laser leveling apparatus, according to an example embodiment.

FIG. 1D is a side view of two laser leveling apparatuses attachable from a first end of a first laser leveling apparatus to a second end of a second laser leveling apparatus, according to an example embodiment.

FIG. 2A is a diagram of two attached laser leveling apparatuses, according to an example embodiment.

FIG. 2B is a diagram of four attached laser leveling apparatuses, according to an example embodiment.

FIG. 3A is a diagram of a laser level attachment apparatus, according to an example embodiment.

FIG. 3B is a diagram illustrating how the laser level attachment is interfaced to a laser leveling apparatus, according to an example embodiment.

FIG. 3C is a diagram of a laser level attached to a laser level attachment apparatus, according to an example embodiment.

FIG. 4 is a diagram of laser leveling system, according to an example embodiment.

### DETAILED DESCRIPTION

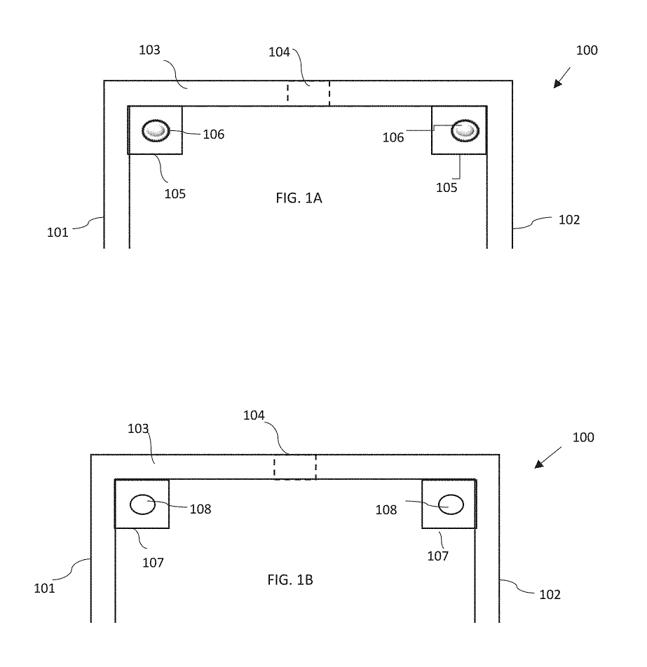

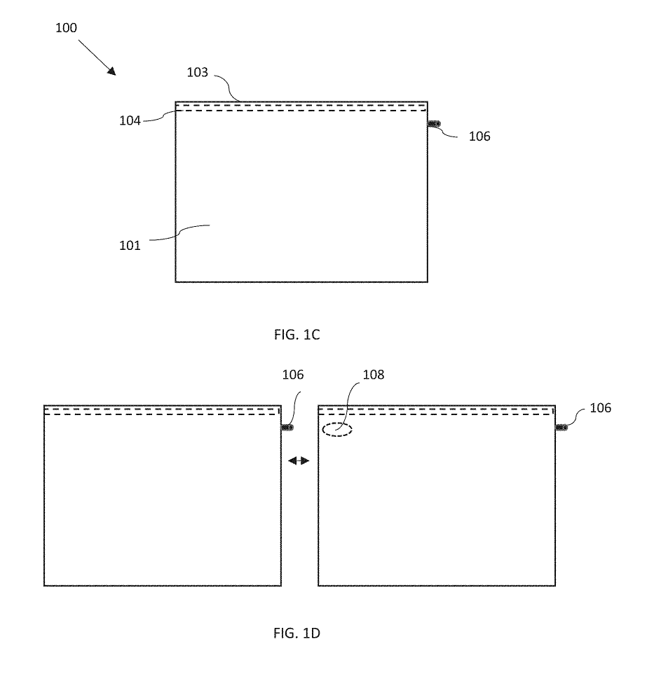

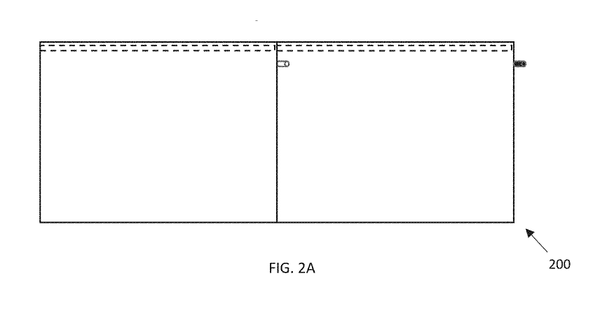

FIG. 1A is first end view of a laser level leveling apparatus 100, according to an example embodiment.

The laser leveling apparatus 100 includes a first side 101, a second side 102, a top 103, a channel 104, side interface attachments 105, and protruding interface mechanisms 106,

The laser leveling apparatus 100 is adapted to be set on a surface, such as a floor, the ground, a manufactured horizontal surface, etc.

In an embodiment, the laser leveling apparatus 100 is designed to rest or lie flush on a floor or horizontal surface.

The area between the first and second sides 101 and 102 is substantially a void, except for the space reserved for the side interface attachments 105 and the protruding interface mechanisms 106.

In an embodiment, the height from the surface upon which the apparatus 100 is placed and the tope 103 is approximately 2 inches. In an embodiment, the width from the first side 101 to the second side 103 is approximately 4 inches. In an embodiment, the length of the apparatus across the top 103 is one of” approximately 1 foot, 2 foot, 3 foot, and 4 foot.

The channel 104 runs the length of the top 103. In an embodiment, the channel is approximately ¼ inch deep (or high) and ½ inch wide. In an embodiment, the channel 104 is recessed into the top 103. In an embodiment, the channel 104 protrudes above a top surface of the top 103. In an embodiment, the channel is made of aluminum and soldered onto the top 103. The channel 104 is substantially centered on the top 103.

The side interface attachments 105 are soldered to a top intersection of the top 103 and the sides 101 and 102. In an embodiment, the side interface attachments 105 are made of aluminum material.

The protruding interface mechanisms 106 are substantially centered within the side interface attachments 105. The protruding interface mechanisms 106 is a bar or a pin that protrudes out from the side interface attachments 105. In an embodiment, the protruding interface mechanisms 106 is approximately 1 inches in length, ¾ inches in width, and ¾ inches in height. In an embodiment, the protruding interface mechanisms 106 are aluminum dowels having ⅜ or ⅝ inch diameters.

The apparatus 100 is shown from a first end (male end) view of the apparatus 100. The second end (female end) view is illustrated in the FIG. 1B.

FIG. 1B is a second end view of a laser leveling apparatus 100, according to an example embodiment.

The second end view illustrates an opposing and opposite end for the view depicted in the FIG. 1A above. The dimensions and materials used for manufacturing the female end view includes manufactured holes 108 in the interface mechanism 107. In an embodiment, these are drilled holes 108 having a diameter of approximately ⅜ of an inch. The manufactured holes 108 correspond to the diameter of the protruding interface mechanisms 106 such that the protruding interface mechanisms 106 lock or snap into the manufactured holes 108 to join two apparatuses 100 together as a single unit.

FIG. 1C is a side view of a laser leveling apparatus 100, according to an example embodiment. The side view illustrates the protruding interface mechanism 106 from a side 101.

FIG. 1D is a side view of two laser leveling apparatuses attachable and removable from a first end of a first laser leveling apparatus 100 to a second end of a second laser leveling apparatus 100, according to an example embodiment.

The protruding interface mechanism 106 from a first end (male end) of a first laser level apparatus snaps into the manufactured hole 108 of a second end (female end) of a second laser level apparatus. In this manner the two laser level apparatuses can be affixed together as a single unit and can be detached from one another to form two separate and independent laser level apparatuses.

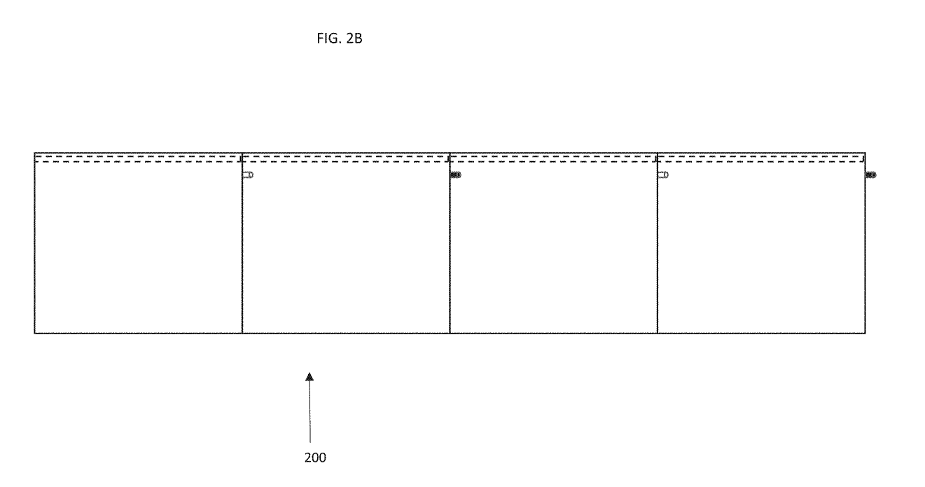

FIG. 2A is a diagram of two attached laser leveling apparatuses, according to an example embodiment. The two separately attached laser level apparatuses form a single integrated laser level apparatus 200.

FIG. 2B is a diagram of four attached laser leveling apparatuses, according to an example embodiment. Here, four independent laser level apparatuses are attached to one another in the manner discussed above to form a single laser level apparatus.

It is to be noted that the length of the integrated and combined laser level apparatus is customizable, such that 2 or 4 is not to be viewed as a limit. In an embodiment, the number of laser level apparatus that are attached to form a single unit is 6 or more.

The length of the combined and integrated laser level apparatus is thusly configurable based on the width of a surface that is to be cured with a UV curing device.

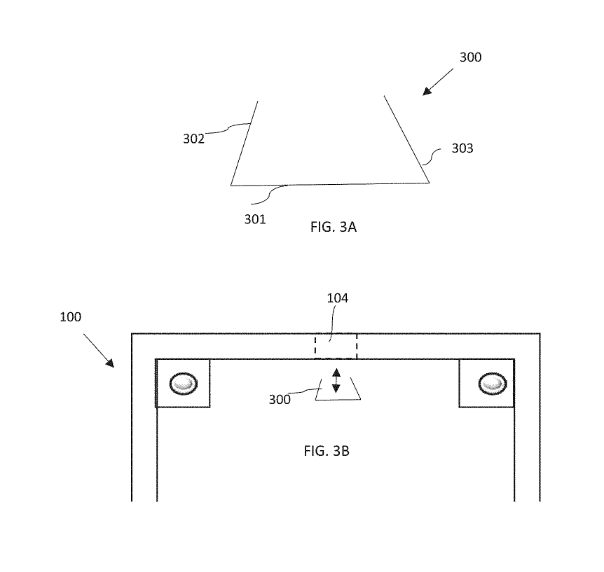

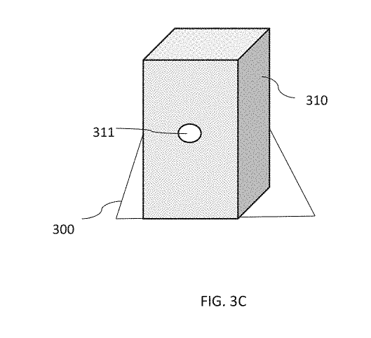

FIG. 3A is a diagram of a laser level attachment apparatus, according to an example embodiment.

The laser level attachment apparatus 300 includes a base 301 and 2 sides 302 and 303 manufactured as a single unit. The length, width, and height of the laser level attachment apparatus 300 can be configured based on the width of the channel 104 and a laser level that is attached between the sides 302 and 303.

FIG. 3B is a diagram illustrating how the laser level attachment s interfaced to a laser leveling apparatus, according to an example embodiment.

The laser level attachment apparatus 300 is movably slid into the channel 104 of a laser level apparatus 100.

FIG. 3C is a diagram of a laser level attached to a laser level attachment apparatus, according to an example embodiment.

The laser level attachment apparatus 300 holds a laser level 310 having a laser 311. The sides 302 and 303 are expandable to accommodate the laser level 310 and hold the laser level 310 in place within the laser level attachment apparatus 300.

In an embodiment, the laser level 310 is a Black and Decker® laser level model BDL220S®,

In an embodiment, the laser level 310 is an equivalent model produced by other manufacturers, such as Stanley®, and others.

The laser level attachment apparatus 300 is adjustable within the channel 104 to position the attached laser level 310 while held on the top 103 of a laser level apparatus 100.

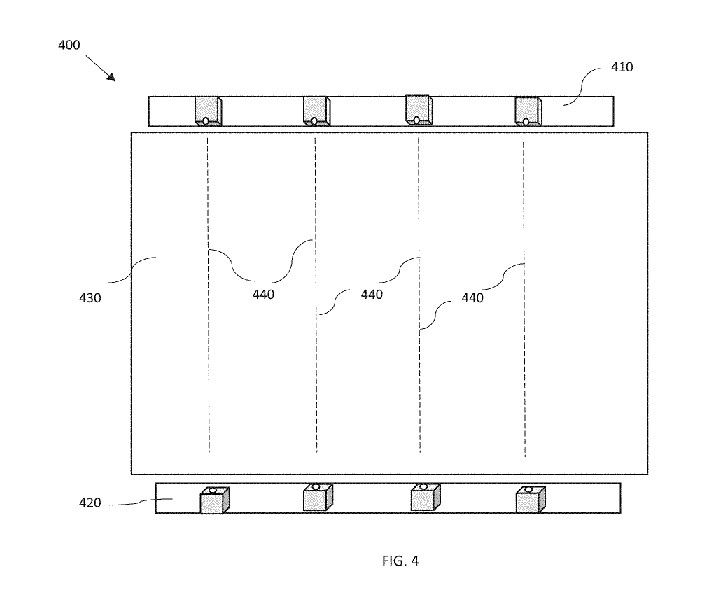

In an embodiment, the laser level 301 snaps or slides into channel 104 such that the angle of the projected laser from the laser level is approximately or exactly at a 90 degree angle with respect to the laser level apparatus 100, such that the projected laser is illuminated horizontally across the surface (floor or ground) upon which the laser level apparatus rests. This ensures that the laser fields created by two or more opposing laser level apparatuses 100 that are situated on opposite sides of the floor align horizontally with one another (as depicted in the FIG. 4 below). Moreover, this makes alignment of the resulting laser fields easy to achieve by pre-manufacturing the channel 104 and the laser level attachment apparatus 300 of the laser level apparatus to ensure that when the laser level 310 is clipped (adhered, or otherwise attached) to the laser level attachment apparatus 300, the resulting laser illuminated from the laser level 310 is automatically aligned such that the laser light (laser beam) is perpendicular to both the floor and the laser level apparatus 100.

FIG. 4 is a diagram of laser leveling system 400, according to an example embodiment.

The laser leveling system 400 includes a first composite laser leveling apparatus 410 and a second composite laser leveling apparatus 420. Lasers 310 are attached to each independent and joined laser level apparatus 100. Each composite apparatus 410 and 420 is comprised of 4 laser level apparatus 100, such that each composite apparatus 410 and 420 includes 4 attached laser levels 310.

The lasers 310 are aligned with one another, such that each laser 310 of the first composite apparatus 410 aligns with a corresponding laser 310 of the second composite apparatus 420. The composite apparatuses 410 and 420 are situated at the ends of a surface 430 that is to have a UV coating cured on that surface. The lasers align to form laser lines 440 on the surface 430, such that when the UV curing device is activated an operator can follow the lines 440 to assure that the UV curing device is aligned with the laser 310 facing the operator and the laser alignment is always visible because when the back of the operator is to a laser 310 of the first composite apparatus 410 and blocking that laser line, the corresponding laser 310 of the second composite apparatus 420 is still illuminating the laser line 440 on the surface 430. This provides for superior application and ensures that the entire surface 403 is being cured by the UV curing device and eliminates operator error.

In an embodiment, the laser lines 310 create a laser field that is projected across a floor (surface 430).

To date, this has been a significant issue in the industry because the manual errors associated with UV curing device operation has resulted in reapplications of the UV coatings and resulted in few enterprises willing to attempt UV coatings on their surfaces (flooring). However, the composite apparatuses 410 and 420, this difficulty associated with operation of UV curing devices is substantially mitigated. Thereby, making UV coatings of surface both practical and economical.

It is noted that a variety of dimensions and materials were discussed herein and above. However, other dimensions and materials may be used without departing from the beneficial teachings discussed herein.

For example, the male and female connection mechanism can be achieved through straps, screws, pins, clips, etc. Affixing the laser to the top of the laser leveling apparatus can be achieved through two sided Velcro® strips, pins, clips, screws, etc. In fact, a variety of variations can be achieved.

Moreover, the composite apparatuses (discussed with the FIG. 4) can be manufactured fit into a corner of a surface (abutting two walls or structures). Here, the attachment of the apparatuses to form a composite device may include a mechanism for attaching two apparatuses to form a 90-degree angle. In an embodiment, the composite apparatuses can be manufactured to join or be joined in a configurable angle to one another. In another embodiment, the composite device may include a mechanism (such as two-sided tape) to adhere from a vertical surface (such as a wall that is perpendicular to a floor that is being UV coated).

In fact, any arrangement of laser leveling apparatus that holds and illuminates therefrom laser lines onto a surface (horizontal or vertical) is intended to fall within various scopes of the present invention.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C. F. R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. An apparatus, comprising:
a first laser level apparatus configured for holding a first laser; and
a second laser level apparatus configured for holding a second laser;
wherein the first laser level apparatus is attachable to the second laser level apparatus to form the apparatus.

2. The apparatus of claim 1, wherein the first laser is adjustable to a position along a length of a top of the first laser level apparatus and the second laser is adjustable to a position on a length of a top of the second laser level apparatus.

3. The apparatus of claim 1, wherein a length of the apparatus is adjustable to a surface length of a surface by attaching additional laser apparatus to the first laser level apparatus or the second laser level apparatus.

4. The apparatus of claim 1, wherein the apparatus is adapted to rest on a horizontal surface to illuminate the first and second lasers onto the surface.

5. The apparatus of claim 1, wherein the apparatus is adapted to be affixed to a vertical surface to illuminate the first and second lasers onto a horizontal surface.

6. The apparatus of claim 1, wherein the first laser level apparatus includes a male end and a female end, and wherein the second laser level apparatus includes a male end and a female end.

7. The apparatus of claim 6, wherein the first laser level apparatus is attached form the male end of the first laser level apparatus to the female end of the second laser level apparatus.

8. The apparatus of claim 1, wherein the first laser level apparatus is detachable from the second laser level apparatus.

9. A system, comprising:
a first composite laser leveling apparatus having a first plurality of lasers situated on a top of the first composite laser leveling apparatus;
a second composite laser leveling apparatus having a second plurality of lasers situated on a top of the second composite laser leveling apparatus;
wherein the first composite laser level apparatus is arranged on a first end of a surface to illuminate a first plurality of laser lines across the surface in a first direction, and the second composite laser level apparatus is arranged on an opposite end of the surface from the first end and oriented to illuminate a second plurality of laser lines across the surface in an opposite second direction from the first direction, such that each first laser line overlaps a corresponding unique second laser line along the surface.

10. The system of claim 9, wherein the first composite laser leveling apparatus is adjustable to a length of the surface, and the second composite laser leveling apparatus is adjustable to the length.

11. The system of claim 9, wherein each first laser is attachable to a unique laser leveling apparatus of the first composite laser leveling apparatus, and wherein each second laser is attachable to unique laser leveling apparatus of the second composite laser leveling apparatus.

12. The system of claim 9, wherein the first composite laser leveling apparatus and the second composite laser leveling apparatus are configured to be disassembled into a plurality of independent laser leveling apparatuses.

13. The system of claim 9, wherein at least one of the first and second composite laser leveling apparatuses is configured to be affixed to a vertical surface and project the corresponding laser lines onto the surface that is a horizontal surface.

14. The system of claim 9, wherein the first and second laser lines are projected onto the surface as a guide for an operator of an Ultraviolet curing device during curing of an Ultraviolet coating applied on the surface.

15. A method, comprising:
illuminating a first set of lasers of a first composite laser level apparatus in a direction along a surface;
illuminating a second set of lasers of a second composite laser leveling apparatus in an opposite direction along the surface; and
aligning first laser lines of the first set of lasers to correspond and overlap second laser lines of the second set of lasers.

16. The method of claim 15 further comprising, operating an Ultraviolet curing device to cure an Ultraviolet coating applied to the surface by following the first and second laser lines on the surface created from the illumination of the aligned first and second lasers.

17. The method of claim 15 further comprising, configuring a length of he first and second composite laser level apparatuses by adding additional laser level apparatuses to match a length of the surface where an Ultraviolet coating is applied on the surface.

18. The method of claim 15 further comprising, adjusting positions of the first lasers along a top of the first composite laser level apparatus and adjusting positions of the second lasers along a top of the second composite laser level apparatus for aligning the first laser lines with the second laser lines.

19. The method of claim 15 further comprising, disassembling the first composite laser leveling apparatus and the second composite laser leveling apparatus into a plurality of independent laser leveling apparatuses.

20. The method of claim 19 further comprising, detaching each first laser and each second laser from the plurality of independent laser leveling apparatuses.
